(19) United States
(12) Patent Application Publication
(10) Pub. No.: US 2026/0277185 A1
(43) Pub. Date: Sep. 17, 2026

(54) IDENTIFICATION METHOD, IDENTIFICATION DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Ryosuke NAGUMO, Tokyo (JP); Shunsaku TOSHIHIRO, Osaka (JP)

(21) Appl. No.: 19/680,085

(22) Filed: May 18, 2026

Related U.S. Application Data
(63) Continuation of application No. PCT/JP2024/038417, filed on Oct. 28, 2024.

(30) Foreign Application Priority Data
Nov. 20, 2023 (JP) 2023-196412

(51) Int. Cl. G05B 19/4065

(52) U.S. Cl. CPC G05B 19/4065; G05B 2219/34475

(57) ABSTRACT

An identification device acquires connection relationship information indicating a mechanical connection relationship between a plurality of servo motors and a connection mechanism, acquires an abnormality degree of each of the plurality of servo motors, identifies a location of abnormality from among the plurality of servo motors and the connection mechanism based on the abnormality degree of each of the plurality of servo motors and the connection relationship information, and displays the location of abnormality on a display.

### FIELD OF INVENTION

The present disclosure relates to a technique for identifying a location of abnormality of a servo system in which a plurality of servo motors is mechanically connected.

### BACKGROUND ART

Patent Literature 1 discloses a technique of estimating a plurality of causal models between variables based on a relationship between a plurality of mechanisms in a process performed on a manufacturing line, acquiring an abnormality detection result of the manufacturing line, and estimating a cause of an abnormality in the plurality of causal models on the basis of a contribution ratio of a variable contributing to the abnormality among the abnormality detection results.

However, the technique described in Patent Literature 1 does not identify a place where no sensor is installed as a location of abnormality. Therefore, if the sensor is not installed in the connection mechanism that mechanically connects the servo motors, there is a problem that when an abnormality occurs in the connection mechanism, the connection mechanism cannot be identified as a location of abnormality.
Patent Literature 1: JP 2023-092184 A

### SUMMARY OF THE INVENTION

The present disclosure has been made to solve such a problem, and an object of the present disclosure is to provide a technique capable of identifying a connection mechanism as a location of abnormality without installing a sensor in the connection mechanism that mechanically connects servo motors.

An identification method according to one aspect of the present disclosure for identifying a location of abnormality of a servo system including a plurality of servo motors and a connection mechanism that mechanically connects the plurality of servo motors, the identification method including a computer configured to execute:
acquiring connection relationship information indicating a mechanical connection relationship between the plurality of servo motors and the connection mechanism;
acquiring an abnormality degree of each of the plurality of servo motors;
identifying the location of abnormality from among each of the plurality of servo motors and the connection mechanism based on the abnormality degree of each of the plurality of servo motors and the connection relationship information; and
displaying the location of abnormality on a display.

According to the present disclosure, the connection mechanism can be identified as a location of abnormality without installing a sensor in the connection mechanism that mechanically connects the servo motors.

### BRIEF DESCRIPTION OF THE DRAWINGS

FIG. 1 is a diagram illustrating a configuration example of a production system according to a first embodiment of the present disclosure.

FIG. 2 is a diagram for explaining an operation mode.

FIG. 3 is a graph illustrating a relationship between a threshold and an abnormality degree.

FIG. 4 is a flowchart illustrating an example of processing of an identification device in a storage phase in which operation data is stored.

FIG. 5 is an explanatory diagram of processing in which operation data is stored in an operation data storage unit.

FIG. 6 is a flowchart illustrating an example of location of abnormality identification processing executed by the identification device according to the first embodiment.

FIG. 7 is a diagram illustrating an example of an abnormality display screen.

FIG. 8 is a diagram illustrating another example of the abnormality display screen.

FIG. 9 is a diagram illustrating an example of a connection relationship display field for displaying a connection relationship of a cooperative servo system.

FIG. 10 is a diagram illustrating a configuration example of a production system according to a second embodiment of the present disclosure.

FIG. 11 is a flowchart illustrating an example of abnormality cause identification processing by the identification device according to the second embodiment.

FIG. 12 is a diagram illustrating an example of an abnormality display screen.

### DETAILED DESCRIPTION

### Knowledge Underlying Present Disclosure

In a production facility in which a servo motor is used, a plurality of servo motors often perform cooperative operations. Specifically, a plurality of servo motors are mechanically connected to each other via a belt, or a plurality of servo motors are mechanically connected to each other via an arm element like a robot arm.

In such a production facility, it is possible to identify an abnormality using a measurement signal of a built-in sensor for a plurality of servo motors. However, when an abnormality occurs in the connection mechanism that mechanically connects the plurality of servo motors, there is a problem that the connection mechanism cannot be identified as a location of abnormality unless a sensor is attached to the connection mechanism.

Here, if the sensors are attached to all the connection mechanisms in which an abnormality may occur, the connection mechanism can be identified as a location of abnormality based on a measurement signal from the sensor. However, it is difficult to provide sensors in all the connection mechanisms due to cost constraints. In addition, there are places where it is difficult to provide a sensor due to physical restrictions.

In the related art for estimating an abnormality cause including Patent Literature 1, there is a problem that a connection mechanism in which a sensor is not installed cannot be identified as a location of abnormality as described above.

The present disclosure has been made to solve such a problem, and an object of the present disclosure is to provide a technique capable of identifying a connection mechanism as a location of abnormality without installing a sensor in the connection mechanism that mechanically connects servo motors.
(1) An identification method according to one aspect of the present disclosure for identifying a location of abnormality of a servo system including a plurality of servo motors and a connection mechanism that mechanically connects the plurality of servo motors, the identification method including a computer configured to execute:
acquiring connection relationship information indicating a mechanical connection relationship between the plurality of servo motors and the connection mechanism;
acquiring an abnormality degree of each of the plurality of servo motors;
identifying the location of abnormality from among each of the plurality of servo motors and the connection mechanism based on the abnormality degree of each of the plurality of servo motors and the connection relationship information; and
displaying the location of abnormality on a display.

According to this configuration, since the abnormality degree of each of the plurality of servo motors and the connection relationship information indicating the mechanical connection relationship of the plurality of servo motors are acquired, not only the plurality of servo motors but also the connection mechanism can be identified as the location of abnormality based on the abnormality degree and the connection relationship information. Therefore, the connection mechanism can be identified as a location of abnormality without installing a sensor in the connection mechanism.
(2) In the identification method according to (1), the connection relationship information may include graph data representing each of the plurality of servo motors as a plurality of blocks and representing the connection relationship by connection lines connecting the plurality of blocks, and the graph data may be generated based on an input operation by an operator.

In this case, since the connection relationship information is configured using the graph data in which the servo motor is indicated by a block and the connection mechanism is indicated by a connection, the connection relationship information can be expressed in an easy-to-understand manner.
(3) In the identification method according to (2), the computer is further configured to execute: displaying the graph data on the display; and displaying a mark indicating the location of abnormality in the block or the connection corresponding to the location of abnormality.

In this case, the location of abnormality can be presented in an easy-to-understand manner.
(4) In the identification method according to any one of (1) to (3), the computer is configured to execute: identifying the location of abnormality from among the plurality of servo motors based on the abnormality degree of each of the plurality of servo motors when the connection relationship information is not acquired; and displaying the abnormality degree corresponding to each of the plurality of servo motors on the display, and visually highlighting the abnormality degree of the servo motor identified as the location of abnormality on the display.

In this case, even when the connection relationship information cannot be acquired, it is possible to avoid a situation in which an abnormality of the servo motor is not presented.
(5) In the identification method according to any one of (1) to (4), when the plurality of servo motors include a first servo motor and a second servo motor that is connected to the first servo motor via the connection mechanism and operates due to operation of the first servo motor, the identifying of the location of abnormality includes: determining whether the abnormality degree of each of the first servo motor and the second servo motor indicates abnormality; identifying the connection mechanism of the first servo motor and the second servo motor as the location of abnormality when it is determined that the abnormality degrees of both the first servo motor and the second servo motor indicate abnormality; and identifying one of the first servo motor and the second servo motor as the location of abnormality when it is determined that the abnormality degree of the one of the first servo motor and the second servo motor indicates an abnormality.

In this case, in the first servo motor and the second servo motor having a causal relationship with the operation, which of the first servo motor, the second servo motor, and the connection mechanism is the location of abnormality can be accurately identified.
(6) In the identification method according to any one of (1) to (7), when the servo system includes an operation unit including a plurality of cooperative servo motors that cooperatively operate among the plurality of servo motors, the identifying of the location of abnormality includes: determining whether the abnormality degree of each of the plurality of cooperative servo motors indicates an abnormality; identifying the operation unit as the location of abnormality when it is determined that the abnormality degrees of all of the plurality of cooperative servo motors indicate an abnormality; and identifying a cooperative servo motor whose abnormality degree indicates an abnormality as the location of abnormality when it is determined that all the abnormality degrees of the plurality of cooperative servo motors do not indicate an abnormality.

In this case, in the plurality of cooperative servo motors, which of the cooperative servo motor and the operation unit is the location of abnormality can be accurately identified.
(7) In the identification method according to any one of (1) to (6), the computer is further configured to execute:
acquiring target operation data from the servo system;
searching for registered operation data having a maximum similarity to the target operation data from a plurality of registered operation data preregistered in a memory and associated with abnormality cause information indicating an abnormality cause, and estimating an abnormality cause indicated by the abnormality cause information associated with the searched registered operation data as an abnormality cause of the servo system; and
displaying the estimated abnormality cause on the display.

In this case, the abnormality cause indicated by the target operation data can be accurately identified, and the identified abnormality cause can be presented.
(8) In the identification method according to (7), the target operation data and the plurality of pieces of registered operation data each include a command signal for driving the servo motor, a measurement signal of the servo motor when the servo motor operates based on the command signal, and the abnormality degree, and the displaying on the display includes displaying the command signal, the measurement signal, and the abnormality degree included in the searched registered operation data, and the command signal, the measurement signal, and the abnormality degree included in the target operation data.

In this case, since the command signal, the measurement signal, and the abnormality cause information included in the retrieved registered operation data and the command signal, the measurement signal, and the abnormality degree corresponding to the target operation data are displayed, the operator can analyze the abnormality cause while comparing these signals.
(9) In the identification method according to (8), the plurality of pieces of registered operation data further includes at least one of: a normal or abnormal determination result by an operator; a measurement date and time of the searched registered operation data; and a description related to a recovery operation for returning the servo system to a normal operation, and the displaying on the display further includes displaying at least one of the determination result, the measurement date and time, and the description related to the recovery operation that are associated with the searched registered operation data.

In this case, since at least one of the determination result, the measurement date and time, the description regarding the cause, and the description regarding the recovery operation that are included in the retrieved registered operation data is displayed, it is possible to present information useful for analyzing the cause of the abnormality.
(10) In the identification method according to (8) or (9), the displaying on the display may further include displaying the command signal, the measurement signal, and the abnormality degree included in the searched registered operation data and the command signal, the measurement signal, and the abnormality degree included in the target operation data such that operation modes can be visually distinguishable from each other.

In this case, the command signal, the measurement signal, and the abnormality degree included in the retrieved registered operation data and the command signal, the measurement signal, and the abnormality degree corresponding to the target operation data are displayed distinguishably for each operation mode, so that the abnormality cause can be analyzed for each operation mode.
(11) In the identification method according to (8) or (9), the similarity may be a similarity between the command signal included in the plurality of pieces of registered operation data and the command signal included in the target operation data.

In this case, the similarity can be accurately calculated.
(12) In the identification method according to any one of (1) to (11), the computer may be any one of a servo amplifier, a motion controller, a personal computer, and a cloud server.

In this case, the location of abnormality is identified by any one of the servo amplifier, the motion controller, the personal computer, and the cloud server.
(13) An identification device according to another aspect of the present disclosure is an identification device for identifying a location of abnormality of a servo system including a plurality of servo motors and a connection mechanism that mechanically connects the plurality of servo motors, the identification device including a processor of the identification device configured to execute: acquiring connection relationship information indicating a mechanical connection relationship between the plurality of servo motors and the connection mechanism; acquiring an abnormality degree of each of the plurality of servo motors; identifying the location of abnormality from among each of the plurality of servo motors and the connection mechanism based on the abnormality degree of each of the plurality of servo motors and the connection relationship information; and displaying the location of abnormality on a display.

According to this configuration, it is possible to provide an identification device capable of identifying a connection mechanism as a location of abnormality without installing a sensor in the connection mechanism.
(14) An identification program according to another aspect of the present disclosure causes a computer to execute an identification method for identifying a location of abnormality of a servo system including a plurality of servo motors and a connection mechanism that mechanically connects the plurality of servo motors, the identification program causing the computer to execute: acquiring connection relationship information indicating a mechanical connection relationship between the plurality of servo motors and the connection mechanism; acquiring an abnormality degree of each of the plurality of servo motors; identifying the location of abnormality from among each of the plurality of servo motors and the connection mechanism based on the abnormality degree of each of the plurality of servo motors and the connection relationship information; and displaying the location of abnormality on a display.

According to this configuration, it is possible to provide an identification program capable of identifying the connection mechanism as a location of abnormality without installing a sensor in the connection mechanism.

The present disclosure can also be realized as a location of abnormality identification system that operates by such a location of abnormality identification program. Further, needless to say, such a computer program can be distributed via a computer-readable non-transitory recording medium such as a CD-ROM or via a communication network such as the Internet.

Note that each of embodiments to be described below illustrates a specific example of the present disclosure. Numerical values, shapes, components, steps, orders of steps, and the like of the embodiments below are merely examples, and are not intended to limit the present disclosure. A component not described in an independent claim representing a highest concept among components in the embodiments below is described as an optional component. Further, in all the embodiments, content of each of the embodiments can be combined.

### First Embodiment

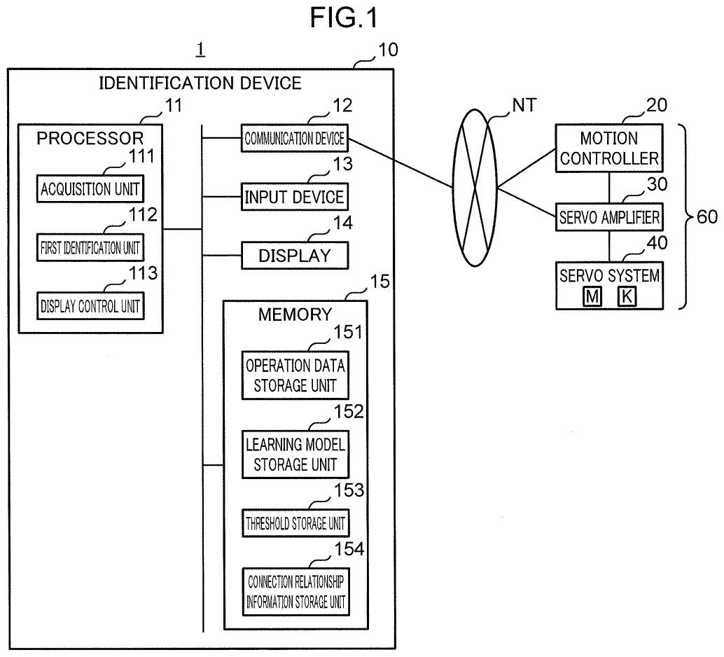

FIG. 1 is a diagram illustrating a configuration example of a production system 1 according to a first embodiment of the present disclosure. The production system 1 includes an identification device 10, a motion controller 20, a servo amplifier 30, and a servo system 40. The motion controller 20, the servo amplifier 30, and the servo system 40 constitute a production facility 60. The production facility 60 is an example of the facility.

The identification device 10 is a device that identifies a location of abnormality of the servo system 40. The servo system 40 includes a plurality of servo motors M and a connection mechanism K that mechanically connects the plurality of servo motors M. The connection mechanism K includes a mechanical member that transmits power of one servo motor M to the other servo motor M. Examples of the connection mechanism K include a belt, an arm mechanism that connects a plurality of joints of a robot arm, and a plate. Details of the configuration of the servo system 40 will be described later.

The identification device 10 may be constituted by a personal computer installed at a site where the motion controller 20, the servo amplifier 30, and the servo system 40 are installed, or may be constituted by a cloud server. The motion controller 20, the servo amplifier 30, and the identification device 10 are connected via a network NT. An example of the network NT is a local area network or the Internet. The motion controller 20 and the servo amplifier 30 and the servo amplifier 30 and the servo system 40 are connected via a LAN cable or the like.

The servo system 40 includes, for example, a production device used to produce a product. An example of the production device is, for example, an industrial robot that performs mounting, processing, machining, conveyance, or the like of equipment. The servo system 40 includes a work arm that grips and processes parts. The work arm includes a plurality of arm elements and one or a plurality of joints connecting the plurality of arm elements. The production device is installed, for example, in a production line of a factory. The production device has been described as being configured by an industrial robot, but this is an example, and may be configured by any device as long as it is a device driven by a servo motor.

The servo motor M is a motor that precisely operates the production device in accordance with a drive signal output from the servo amplifier 30. For example, the servo motor M is provided at a joint of the work arm, and rotates the arm element by a predetermined angle in a forward rotation direction or a reverse rotation direction. The servo motor M includes a sensor (not illustrated) that detects the state of the servo motor M, and inputs a measurement signal detected by the sensor to the servo amplifier 30. An example of the sensor is a torque sensor that detects the torque of the servo motor M. Therefore, the measurement signal is a torque signal. However, this is an example, and the measurement signal may be an acceleration signal or a speed signal, not limited to the torque signal.

The servo amplifier 30 controls the servo motor M such that the servo motor M operates in accordance with a command signal output from the motion controller 20. The servo amplifier 30 generates a drive signal corresponding to the command signal output from the motion controller 20 and inputs the drive signal to the servo motor M. Based on the measurement signal output from the servo motor M, the servo amplifier 30 feedback-controls the servo motor M so that the servo motor M performs an operation according to the command signal.

The motion controller 20 generates a command signal for operating the servo motor M in a predetermined operation pattern, and inputs the generated command signal to the servo amplifier 30. The command signal is time-series data that specifies the position of the servo motor M from the start to the end of one operation pattern.

Although the command signal is described as the position command signal that specifies the position of the servo motor M, this is an example, and the command signal may be a speed command signal, an acceleration command signal, or a torque command signal that specifies the speed, acceleration, or torque of the servo motor M. Alternatively, the command signal may include at least two of a position command signal, a speed command signal, an acceleration command signal, and a torque command signal.

The identification device 10 includes a processor 11, a communication device 12, an input device 13, a display 14, and a memory 15. The processor 11 is configured using a central processing unit (CPU), and includes an acquisition unit 111, a first identification unit 112, and a display control unit 113. Note that the acquisition unit 111 to the display control unit 113 may be configured by a dedicated integrated circuit such as an ASIC.

The acquisition unit 111 acquires the command signal and the measurement signal transmitted from the servo amplifier 30 using the communication device 12. The acquisition unit 111 generates operation data on the basis of the acquired command signal and measurement signal, and stores the operation data in the operation data storage unit 151.

The acquisition unit 111 acquires connection relationship information indicating a mechanical connection relationship between the plurality of servo motors M and the connection mechanism K from the connection relationship information storage unit 154. The connection relationship information includes graph data indicating each of the plurality of servo motors M by a plurality of blocks and indicating a connection relationship connecting the plurality of blocks. The graph data is generated based on an input operation by the operator. The operator arranges a block corresponding to the servo motor M on the screen of the drawing application based on the actual configuration of the servo system 40, and performs an input operation of connecting the arranged blocks by connection according to the connection relationship between the servo motors M to generate graph data. The acquisition unit 111 generates connection relationship information including the input graph data, and stores the generated connection relationship information in the connection relationship information storage unit 154. Therefore, the connection relationship information is information created in advance. The operator is a person who manages the production facility 60.

The acquisition unit 111 acquires the abnormality degree indicating the temporal transition of the abnormality degree of each of the plurality of servo motors M. Specifically, the acquisition unit 111 acquires the abnormality degree by inputting the command signal and the measurement signal transmitted from the servo amplifier 30 to the learning model stored in the learning model storage unit 152.

The learning model is generated by performing unsupervised machine learning on operation data (hereinafter, referred to as normal data) of the servo system 40 in a normal state. The learning model is a model to which the command signal and the measurement signal are input, and outputs the abnormality degree of the servo system 40 from the input command signal and measurement signal. Therefore, as the learning data of the learning model, the command signal and the measurement signal at the normal time included in the operation data stored in the operation data storage unit 151 are used.

As an algorithm of the learning model, for example, a k-nearest neighbor algorithm, a k-means method, or the like can be adopted. The abnormality degree is an index representing degree of deviation between the operation data and the normal data, and a value of the abnormality degree increases as the degree of deviation from the normal data increases, and a value of the abnormality degree decreases as the degree of deviation from the normal data decreases.

Hereinafter, an example of processing of the learning model in a case where the k-nearest neighbor algorithm is adopted will be described. The learning model calculates distances between a command signal and a measurement signal to be determined and a plurality of normal command signals and measurement signals. Next, the learning model extracts, from the plurality of command signals and measurement signals at a normal time, the top k command signals and measurement signals at a normal time in order of closest distance to the command signal and the measurement signal to be determined. Next, the learning model calculates, as the abnormality degree, an average value of distances between the extracted top k command signals and measurement signals and the command signals and measurement signals to be determined. As the distance, a Euclidean distance between a vector defined by the value of the command signal and the value of the measurement signal in a normal time at a certain time point t and a vector defined by the value of the command signal and the value of the measurement signal to be determined at the time point t is adopted. As a result, the abnormality degree includes time-series data calculated according to the time point t.

The first identification unit 112 identifies a location of abnormality from among each of the plurality of servo motors M and the connection mechanism K based on the abnormality degree of each of the plurality of servo motors M and the connection relationship information. Details of identification of the location of abnormality will be described later.

The display control unit 113 displays the location of abnormality identified by the first identification unit 112 on the display 14.

The display control unit 113 displays graph data included in the connection relationship information on the display 14, and displays a mark indicating a location of abnormality in a block or connection corresponding to the location of abnormality.

The communication device 12 connects the identification device 10 to the network NT. The communication device 12 receives a command signal and a measurement signal corresponding to the command signal from the servo amplifier 30. The communication device 12 may receive the command signal and the measurement signal corresponding to the command signal from the motion controller 20.

The input device 13 includes a mouse, a keyboard, a touch panel, or the like, and receives an instruction from a user.

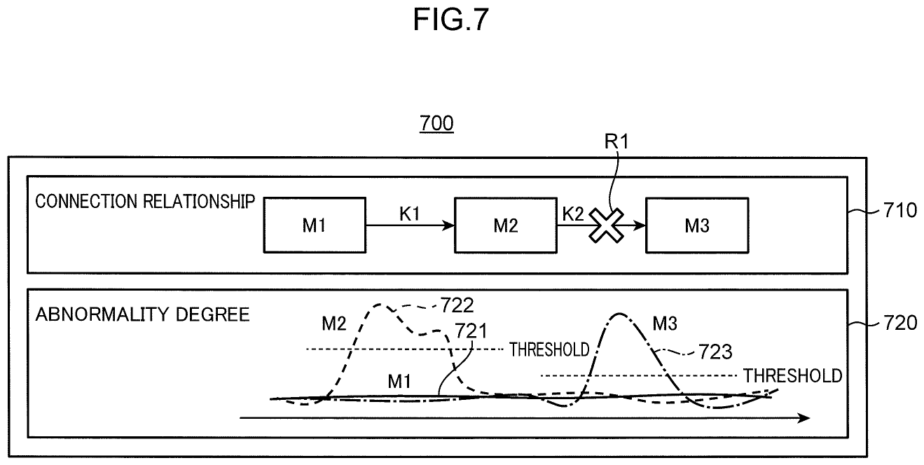

The display 14 includes a display device such as a liquid crystal display or an organic EL display, and displays an abnormality display screen 700 illustrated in FIG. 7.

The memory 15 includes a hard disk drive (HDD) or a solid state drive (SSD). The memory 15 includes an operation data storage unit 151, a learning model storage unit 152, a threshold storage unit 153, and a connection relationship information storage unit 154.

The operation data storage unit 151 stores the operation data generated by the acquisition unit 111.

The learning model storage unit 152 stores a learning model to which the command signal and the measurement signal are input and which outputs an abnormality degree. Note that the learning model may include a learning model machine-learned in advance for each operation mode. For example, the learning model may include learning models corresponding to an acceleration mode, a deceleration mode, a transient mode, and a steady mode. For example, the learning model for the acceleration mode is generated by unsupervised machine learning of the command signal and the measurement signal at the normal time in the acceleration mode. In this case, the acquisition unit 111 may calculate the abnormality degree by inputting the command signal and the measurement signal to the learning model of the corresponding operation mode such that the command signal and the measurement signal of the acceleration mode are input to the learning model for the acceleration mode and the command signal and the measurement signal of the deceleration mode are input to the learning model for the deceleration mode.

The threshold storage unit 153 stores a threshold to be compared with the abnormality degree calculated by the learning model. In the present embodiment, as the threshold, a threshold corresponding to each of the acceleration mode, the deceleration mode, the transient mode, and the steady mode are stored.

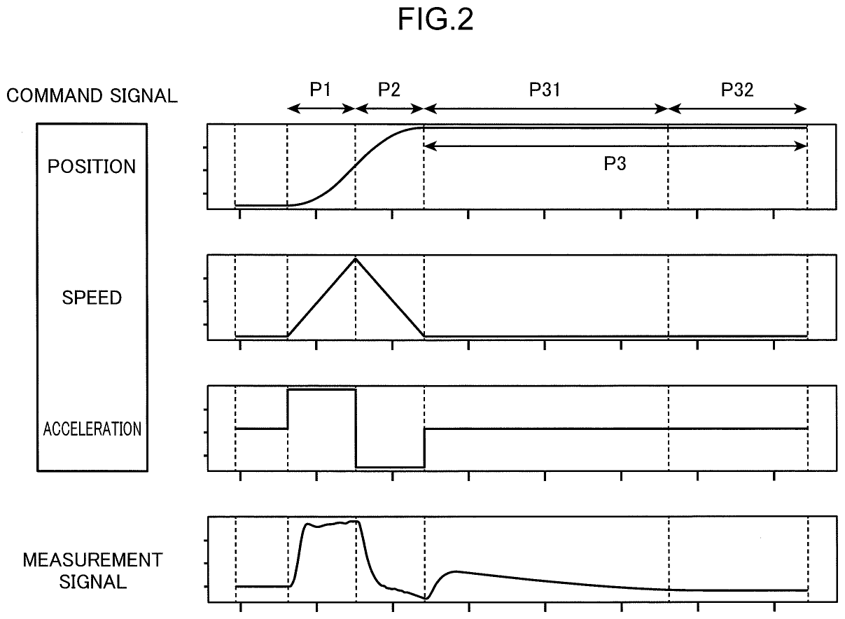

FIG. 2 is a diagram for describing an operation mode. In FIG. 2, waveforms of a position command signal, a speed command signal, an acceleration command signal, and a measurement signal are illustrated in order from the top.

The operation period of the servo motor M is divided into an acceleration period P1, a deceleration period P2, and a constant-speed period P3. The constant-speed period P3 is divided into a transient period P31 including an initial stage of the constant-speed period P3 and a steady period P32 including an end stage of the constant-speed period P3. The transient period P31 is a period in which the value of the speed command signal is 0 but the value of the measurement signal is larger than a predetermined value due to inertia. The steady period P32 is a period in which the value of the measurement signal is equal to or less than a predetermined value.

The acquisition unit 111 acquires the position command signal from the servo amplifier 30, and generates the speed command signal by differentiating the acquired position command signal. The acquisition unit 111 generates an acceleration command signal by differentiating the speed command signal. The acquisition unit 111 sets a period in which an absolute value of the acceleration command signal is more than or equal to a certain value and the sign is positive as the acceleration period P1. Further, the acquisition unit 111 sets a period in which an absolute value of the acceleration command signal is equal to or more than a certain value and the sign is negative as the deceleration period P2. The acquisition unit 111 sets a period in which the absolute value of the acceleration command signal is less than a certain value as the constant-speed period P3. The acquisition unit 111 sets a period from the start time point of the constant-speed period P3 until a predetermined time elapses as the transient period P31. In the constant-speed period P3, the acquisition unit 111 sets the remaining period from the end point of the transient period P31 as the steady period P32.

The acquisition unit 111 determines the operation mode of the servo motor M in the acceleration period P1 as the acceleration mode, the operation mode of the servo motor M in the deceleration period P2 as the deceleration mode, the operation mode of the servo motor M in the constant-speed period P3 as the constant-speed mode, the operation mode of the servo motor M in the transient period P31 as the transient mode, and the operation mode of the servo motor M in the steady period P32 as the steady mode.

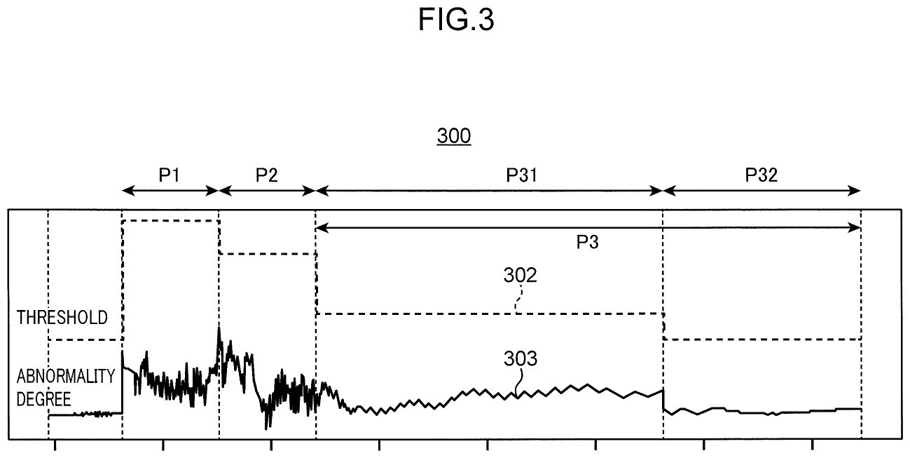

FIG. 3 is a graph 300 illustrating a relationship between a threshold and an abnormality degree. In FIG. 3, the vertical axis represents the abnormality degree, and the horizontal axis represents time. An abnormality degree 303 is divided into an acceleration period P1, a deceleration period P2, and a constant-speed period P3, and the constant-speed period P3 is further divided into a transient period P31 and a steady period P32. A threshold 302 is set to a different value for each operation period, that is, a different value for each operation mode. In this example, the threshold 302 decreases in the order of the acceleration period P1, the deceleration period P2, the transient period P31, and the steady period P32. The acquisition unit 111 determines that the servo system 40 is abnormal when the abnormality degree 303 is greater than or equal to the threshold 302, and determines that the servo system 40 is normal when the abnormality degree 303 is less than the threshold. Therefore, for example, the steady period P32 is more likely to be determined to be abnormal than the acceleration period P1 and the deceleration period P2. In this way, by setting the threshold to a different value according to the operation mode, it is possible to perform appropriate abnormality determination according to the operation mode.

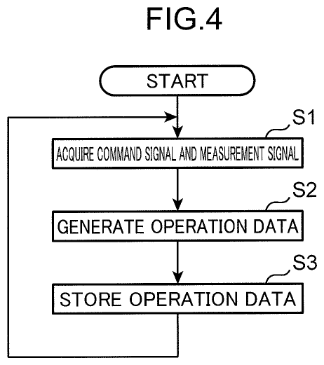

FIG. 4 is a flowchart illustrating an example of processing of the identification device 10 in the storage phase in which the operation data is stored. First, in step S1, the acquisition unit 111 acquires the command signal and the measurement signal transmitted from the servo amplifier 30 using the communication device 12. When the production facility 60 is in operation, the servo amplifier 30 transmits the command signal and the measurement signal at a predetermined sampling rate, so that the acquisition unit 111 acquires the command signal and the measurement signal at the predetermined sampling rate.

Next, in step S2, the acquisition unit 111 generates operation data by giving an identifier to the command signal and the measurement signal acquired in step S1. Here, the operation data is managed in units of one operation pattern. Therefore, when acquiring all the time-series data of the command signal and the measurement signal from the start to the end of one operation pattern, the acquisition unit 111 assigns the identifier and the measurement date and time of the operation data to the time-series data of the command signal and the measurement signal, and generates the operation data.

Next, in step S3, the acquisition unit 111 stores the operation data generated in step S2 in the operation data storage unit 151. The operator can input a determination result of normality or abnormality, a description on a cause of the abnormality, and a description on a work for returning the production facility 60 to the normal operation to the stored operation data from a cause display screen 900 described in the second embodiment. When these pieces of information are input, the acquisition unit 111 may include these pieces of information in the content of the operation data. When the processing of step S3 ends, the processing returns to step S1. That is, the processing of FIG. 4 is repeatedly executed when the production facility 60 is in operation.

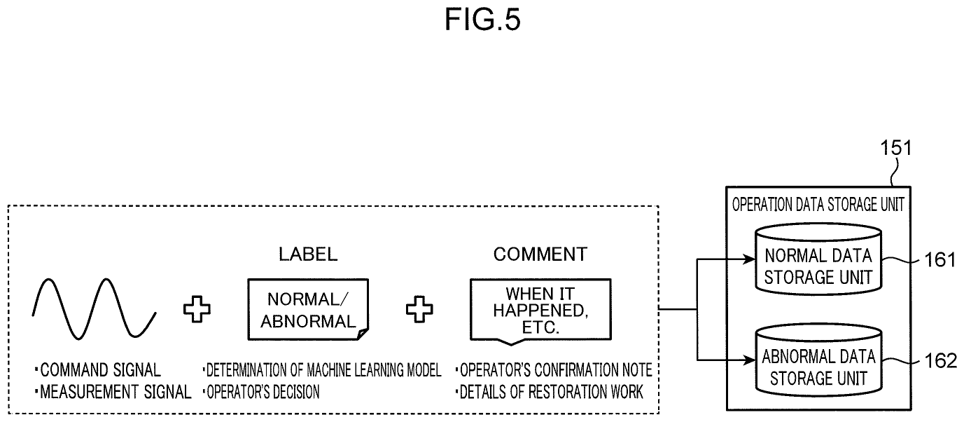

FIG. 5 is an explanatory diagram of processing in which operation data is stored in the operation data storage unit 151. When acquiring the command signal and the measurement signal corresponding to one operation pattern, the acquisition unit 111 calculates the abnormality degree by inputting the acquired command signal and measurement signal to the learning model. The acquisition unit 111 compares the abnormality degree with a threshold, and determines whether the servo system 40 is abnormal or normal. When determining that there is an abnormality, the acquisition unit 111 associates the abnormality label with the command signal and the measurement signal. On the other hand, when determining that it is normal, the acquisition unit 111 associates the normal label with the command signal and the measurement signal.

When an operator who has actually confirmed the presence or absence of an abnormality of the servo system 40 inputs an instruction indicating the abnormality using the input device 13, the acquisition unit 111 associates the abnormality label with the command signal and the measurement signal. On the other hand, when an instruction indicating normality is input by the operator using the input device 13, the acquisition unit 111 associates the normal label with the command signal and the measurement signal.

When the operator inputs a comment using the input device 13, the acquisition unit 111 associates the comment with the command signal and the measurement signal. The comment includes a date and time of occurrence of abnormality, a memo describing a confirmation content for the servo system 40, a content of a recovery work, and the like.

The acquisition unit 111 generates operation data by associating a label and a comment with the command signal and the measurement signal, and stores the generated operation data in the operation data storage unit 151. At this time, the acquisition unit 111 stores the operation data including the normal label in a normal data storage unit 161, and stores the operation data including the abnormal label in an abnormal data storage unit 162.

In this manner, the acquisition unit 111 distinguishes the operation data including the normal label from the operation data including the abnormal label and accumulates the operation data in the operation data storage unit 151.

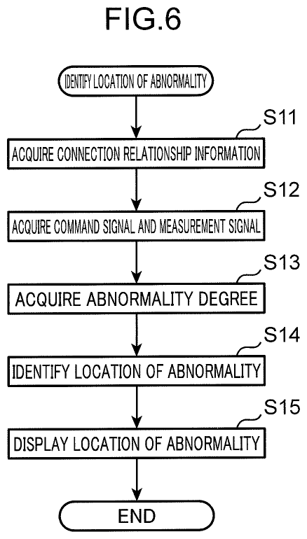

FIG. 6 is a flowchart illustrating an example of location of abnormality identification processing executed by the identification device 10 according to the first embodiment. In step S11, the acquisition unit 111 acquires the connection relationship information from the connection relationship information storage unit 154.

Next, in step S12, the acquisition unit 111 acquires the command signal and the measurement signal from the servo amplifier 30.

Next, in step S14, the acquisition unit 111 acquires the abnormality degree by inputting the command signal and the measurement signal acquired in step S12 to the learning model.

Next, the first identification unit 112 identifies a location of abnormality on the basis of the connection relationship information acquired in step S11 and the abnormality degree acquired in step S13.

FIG. 7 is a diagram illustrating an example of the abnormality display screen 700. Hereinafter, details of the identification processing of the location of abnormality will be described with reference to FIG. 7. The abnormality display screen 700 includes a connection relationship display field 710 and an abnormality degree display field 720. The connection relationship display field 710 displays graph data included in the connection relationship information. In this example, the servo system 40 including three servo motors M1, M2, and M3 and two connection mechanisms K1 and K2 is displayed. Each of the servo motors M1, M2, and M3 is indicated by a block. Each of the connection mechanisms K1 and K2 is displayed as connection lines connecting the blocks.

The servo motor M1 and the servo motor M2 are connected via the connection mechanism K1. The connection mechanism K1 transmits the operation of the servo motor M1 to the servo motor M2. The servo motor M2 operates due to the operation of the servo motor M1. The servo motor M2 and the servo motor M3 are connected via the connection mechanism K2. The connection mechanism K2 transmits the operation of the servo motor M2 to the servo motor M3. The servo motor M3 operates due to the operation of the servo motor M2.

The connection arrow indicates the power transmission direction of the servo motor M. In this example, power is transmitted from the servo motor M1 to the servo motor M2, and power is transmitted from the servo motor M2 to the servo motor M3. Therefore, the connection arrow corresponding to the connection mechanism K1 is directed from the servo motor M1 to the servo motor M2, and the connection arrow corresponding to the connection mechanism K2 is directed from the servo motor M2 to the servo motor M3. In this manner, the connection relationship of the servo system 40 in which one servo motor M operates due to the operation of the other servo motor M is referred to as a causal type.

The abnormality degree display field 720 displays a graph illustrating a temporal transition of the abnormality degree of each of the servo motors M1 to M3 displayed in the connection relationship display field 710. The vertical axis of the graph represents the abnormality degree, and the horizontal axis represents time. The abnormality degrees 721, 722, and 723 indicate the abnormality degrees of the servo motors M1, M2, and M3, respectively.

In this example, the abnormality degree 721 of the servo motor M1 does not exceed the threshold, but the abnormality degree 722 of the servo motor M2 exceeds the threshold. Thereafter, the abnormality degree 723 of the servo motor M3 exceeds the threshold. The servo motor M is a component that is inherently less prone to failure. Therefore, there is a low possibility that an abnormality has occurred in both the servo motor M2 and the servo motor M3, and there is a high possibility that an abnormality has occurred in the connection mechanism K2. Therefore, the first identification unit 112 does not identify the servo motors M2 and M3 as location of abnormalities, but identifies the connection mechanism K2 as a location of abnormality.

That is, the first identification unit 112 determines whether the abnormality degrees 721, 722, and 723 of the servo motor M1 (an example of a first servo motor), the servo motor M2 (an example of first and second servo motors), and the servo motor M3 (an example of a second servo motor) indicate abnormality. Here, the first identification unit 112 may determine that the abnormality degrees 721 to 723 indicate an abnormality when the period in which the abnormality degrees 721 to 723 exceed the threshold is equal to or longer than a predetermined time. When determining that the abnormality degree of both the servo motor M2 and the servo motor M3 indicates an abnormality, the first identification unit 112 identifies the connection mechanism K2 provided between the servo motor M2 and the servo motor M3 as a location of abnormality.

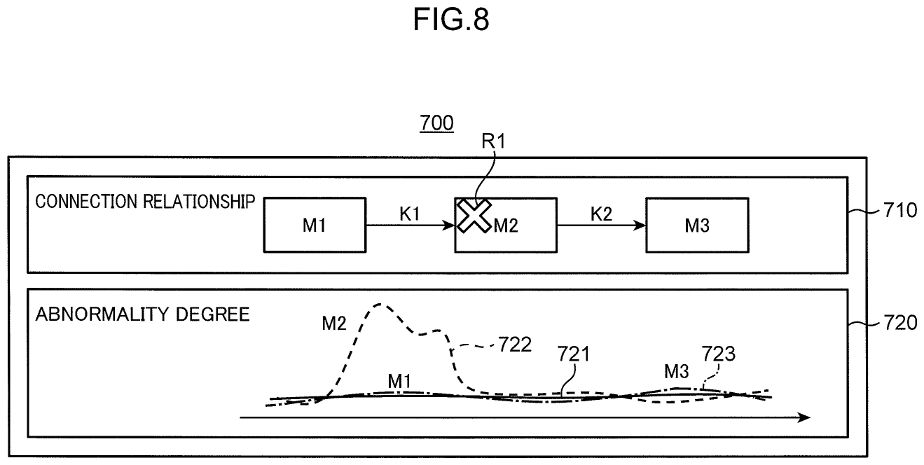

FIG. 8 is a diagram illustrating another example of the abnormality display screen 700. In FIG. 8, the configuration of the servo system 40 is the same as that in FIG. 7. In this example, only the servo motor M2 has the abnormality degree 722 indicating an abnormality. Therefore, the first identification unit 112 identifies the servo motor M2 as a location of abnormality. That is, when determining that the abnormality degree of one servo motor M2 of the servo motors M2 and M3 on both sides of the connection mechanism indicates an abnormality, the first identification unit 112 identifies the one servo motor M2 as a location of abnormality, not the connection mechanism K2.

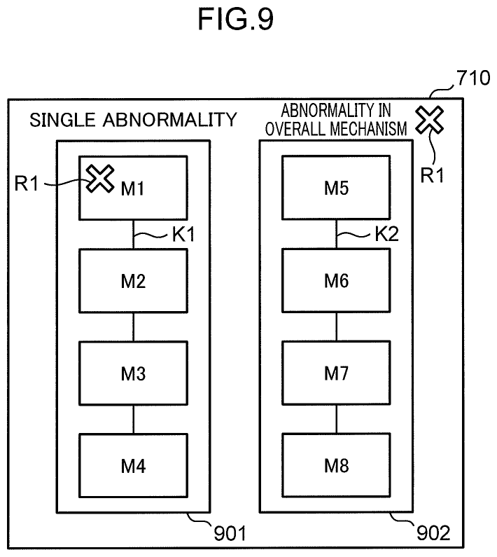

FIG. 9 is a diagram illustrating an example of the connection relationship display field 710 that displays a connection relationship of the cooperative servo system 40. Hereinafter, an abnormality identification method of the cooperative servo system 40 will be described with reference to FIG. 9. The cooperative type is the servo system 40 in which a plurality of servo motors M cooperatively operate one connection mechanism K. For example, a configuration in which an axle of a vehicle is cooperatively operated by a plurality of servo motors M corresponds to the cooperative servo system 40.

The servo system 40 illustrated in FIG. 9 includes two operation units 901 and 902. The operation unit 901 includes four servo motors M1 to M4. The servo motors M1 to M4 are an example of a cooperative servo motor that cooperatively operates the connection mechanism K1. An example of the connection mechanism K1 is an axle. The operation unit 902 is also configured identically to the operation unit.

In the operation unit 901, the first identification unit 112 determines that the abnormality degree indicates the abnormality only in the servo motor M1. In this case, the first identification unit 112 identifies the servo motor M1 as a location of abnormality.

On the other hand, the first identification unit 112 determines that the abnormality degree of each of the servo motors M5 to M8 indicates an abnormality in the operation unit 902. In general, since the servo motor M hardly fails, it is difficult to consider that all the servo motors M5 to M8 constituting the operation unit 902 fail simultaneously, and there is a high possibility that the connection mechanism K2 fails. Therefore, the first identification unit 112 identifies not the servo motors M5 to M8 but the connection mechanism K2 as a location of abnormality.

It is assumed that the abnormality degrees of the servo motors M1 and M2 in the operation unit 901 indicate abnormality. Although it is rare that the plurality of servo motors M1 and M2 fail simultaneously, there is a high possibility that the servo motors M1 and M2 fail if the abnormality degrees of the servo motors M3 and M4 connected to the common connection mechanism K1 do not indicate abnormality. In this case, the first identification unit 112 identifies the servo motors M1 and M2 as location of abnormalities.

See FIG. 6 again. In step S15, the display control unit 113 displays a location of abnormality. In the example of FIG. 7, since the connection mechanism K2 is identified as a location of abnormality, the display control unit 113 displays a mark R1 indicating the location of abnormality on the servo motor M2. In the example of FIG. 8, since the servo motor M2 is identified as a location of abnormality, the mark R1 is displayed for the servo motor M2. In the example of FIG. 9, since the servo motor M1 and the operation unit 902 are identified as location of abnormalities, the display control unit 113 displays the mark R1 for the servo motor M1 and the operation unit 902.

As described above, according to the present embodiment, since the abnormality degree of each of the plurality of servo motors M and the connection relationship information indicating the mechanical connection relationship of the plurality of servo motors M is acquired, not only the plurality of servo motors but also the connection mechanism K can be identified as the location of abnormality based on the abnormality degree and the connection relationship information. Therefore, the connection mechanism K can be identified as a location of abnormality without installing a sensor in the connection mechanism K.

### Second Embodiment

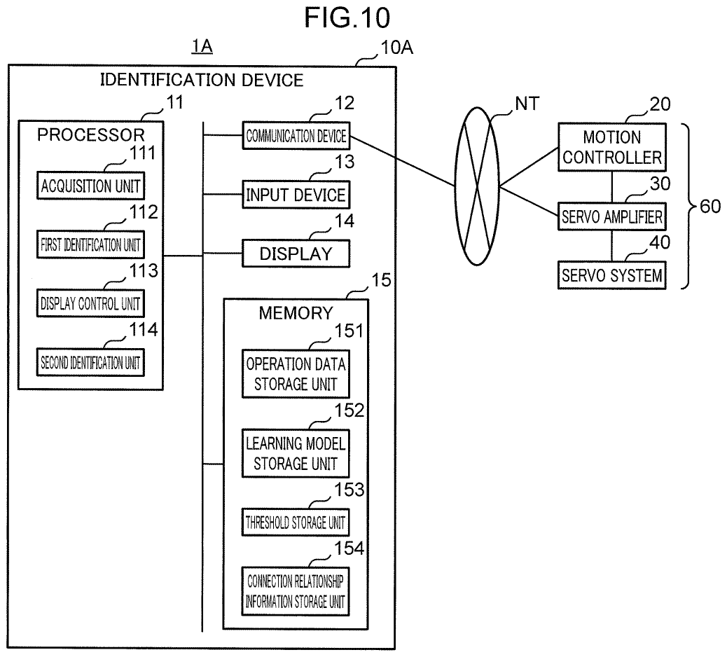

An identification device 10A of the second embodiment identifies an abnormality cause of the servo system 40. FIG. 10 is a diagram illustrating a configuration example of a production system 1A according to the second embodiment of the present disclosure. Note that, in the present embodiment, the same components as those in the first embodiment are denoted by the same reference numerals, and description thereof will be omitted. In the identification device 10A, the processor 11 further includes a second identification unit 114 with respect to the identification device 10.

The acquisition unit 111 acquires a command signal and a measurement signal from the servo amplifier 30 and stores the command signal and the measurement signal in the operation data storage unit 151. Here, the acquired command signal and measurement signal are examples of the target operation data. The target operation data is operation data to be used for identifying an abnormality cause. In the present embodiment, the operation data stored in the operation data storage unit 151 is referred to as registered operation data.

The target operation data and the registered operation data each include a command signal for driving the servo motor M, a measurement signal of the servo motor M when the servo motor operates based on the command signal, and an abnormality degree obtained by inputting the command signal and the measurement signal to the learning model.

The registered operation data includes a determination result of normality or abnormality by the operator, a measurement date and time of the searched registered operation data, abnormality cause information, and a description related to a recovery operation for returning the servo system 40 to a normal operation. The abnormality cause information is a description of an abnormality cause input by an operator.

The second identification unit 114 searches for registered operation data having the maximum similarity to the target operation data from among a plurality of registered operation data preregistered in the operation data storage unit 151 and associated with the abnormality cause information indicating the abnormality cause. The second identification unit 114 estimates the abnormality cause indicated by the abnormality cause information associated with the searched registered operation data as the abnormality cause of the servo system 40. A result of determination of normality or abnormality by the operator, a description of a cause of the abnormality by the operator, and a description of work for returning the servo system 40 to a normal operation are input by the operator on the cause display screen 900. The measurement date and time of the operation data is the year, month, day, and time when the measurement signal included in the operation data is measured. Furthermore, the operation data may include determination results of normality and abnormality determined by the acquisition unit 111 based on the abnormality degree output by the learning model.

The similarity is a similarity between the command signal included in the plurality of pieces of registered operation data and the command signal included in the target operation data. Here, the command signal included in the plurality of pieces of registered operation data is referred to as a registration command signal, and the command signal included in the target command signal is referred to as a target command signal. The similarity is defined by a difference between the registration command signal and the target command signal. This difference is a value obtained by summing the differences between the values of the registration command signal and the target command signal calculated for each of the plurality of sample points from the start point to the end point of the target command signal. The similarity increases as the difference between the registration command signal and the target command signal decreases.

The display control unit 113 displays the abnormality cause estimated by the second identification unit 114 on the display 14.

The display control unit 113 displays the command signal, the measurement signal, and the abnormality degree included in the registered operation data searched by the second identification unit 114, and the command signal, the measurement signal, and the abnormality degree included in the target operation data.

The display control unit 113 displays the determination result, the measurement date and time, the description regarding the cause, and the description regarding the return work associated with the searched registered operation data on the display 14.

The display control unit 113 displays the command signal, the measurement signal, and the abnormality degree included in the registered operation data searched by the second identification unit 114, and the command signal, the measurement signal, and the abnormality signal included in the target operation data such that the operation modes can be distinguished from each other.

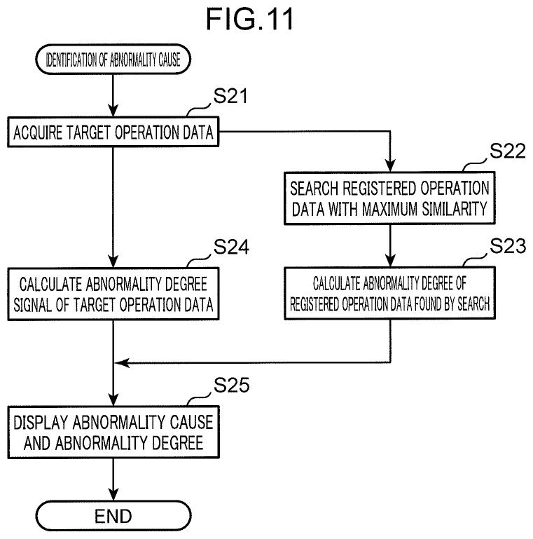

FIG. 11 is a flowchart illustrating an example of the abnormality cause identification processing by the identification device 10A according to the second embodiment. First, in step S21, the acquisition unit 111 acquires target operation data from the servo amplifier 30. The target operation data includes a command signal and a measurement signal.

Hereinafter, the processing of steps S22 and S23 and the processing of step S24 are performed in parallel. In step S22, the second identification unit 114 searches for the registered operation data having the maximum similarity to the target operation data from the plurality of registered operation data stored in the operation data storage unit 151. Specifically, the second identification unit 114 searches for the registered operation data having the maximum similarity by comparing the command signal included in the plurality of pieces of registered operation data with the command signal included in the target operation data. Hereinafter, the registered operation data having the maximum similarity is referred to as search registered operation data.

In step S23, the second identification unit 114 calculates the abnormality degree of the search registered operation data. Specifically, the second identification unit 114 calculates the abnormality degree of the search registered operation data by inputting the command signal and the measurement signal included in the search registered operation data to the learning model.

In step S24, the second identification unit 114 calculates the abnormality degree of the target operation data. Specifically, the second identification unit 114 calculates the abnormality degree of the target operation data by inputting the command signal and the measurement signal included in the target operation data to the learning model.

Next, in step S25, the second identification unit 114 displays, on the display 14, the cause display screen 900 that displays the abnormality cause indicated by the abnormality cause information included in the search registered operation data and the abnormality degree of each of the target operation data and the search registered operation data.

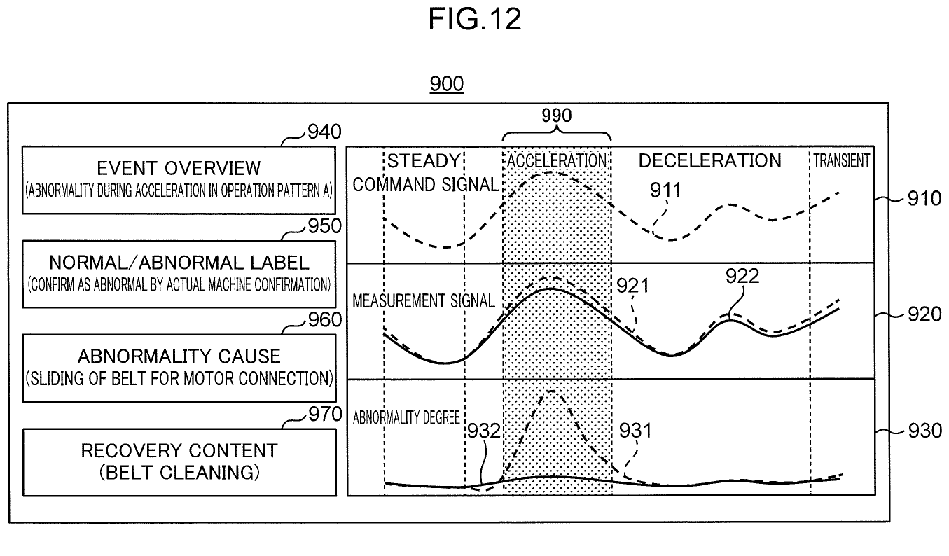

FIG. 12 is a diagram illustrating an example of the cause display screen 900. A first display field 910, a second display field 920, and a third display field 930 are displayed in a right field of the cause display screen 900. The first display field 910 displays a command signal 911 of the target operation data. The second display field 920 displays a measurement signal 921 included in the target operation data and a measurement signal 922 included in the search registered operation data in a superimposed manner. The third display field 930 displays an abnormality degree 931 of the target operation data and an abnormality degree 932 of the search operation data in a superimposed manner. In the first display field 910 to the third display field 930, the vertical axis represents the value of each signal, and the horizontal axis represents time. That is, the first display field 910 to the third display field 930 display the command signal 911, the measurement signals 921 and 922, and the abnormality degrees 931 and 932 in time series.

The first display field 910 to the third display field 930 distinctively display an acceleration period, a deceleration period, a transient period, and a steady period. For example, the first display field 910 to the third display field 930 display the background of each operation period in different colors, display a boundary line in each operation period, or display characters indicating the operation period in each operation period, thereby distinguishing and displaying each operation period. As a result, the first display field 910 to the third display field 930 can distinguish and display each of the plurality of operation modes.

The first display field 910 to the third display field 930 display an emphasized object 990 indicating that the abnormality degree has been changed. Here, the emphasized object 990 is displayed during a period in which the abnormality degree 931 is equal to or greater than the threshold. The emphasized object 990 is an object that displays a rectangular region indicating a period in which the abnormality degree 931 is equal to or greater than a threshold in a translucent color.

The left field of the cause display screen 900 displays an event summary display field 940, a label display field 950, an abnormality cause display field 960, and a restoration content display field 970.

The event summary display field 940 displays an event corresponding to the command signal 911 displayed in the first display field 910. The event is information indicating an event that has occurred in the servo system 40. In this example, since an abnormality has occurred in the acceleration period in an operation pattern A, a message indicating that the abnormality has occurred is displayed as an event.

The label display field 950 is a field in which an operator who has actually confirmed the presence or absence of abnormality of the servo system 40 inputs a confirmation result. The operator determined a normal result inputs a comment indicating normal to the label display field 950, and the operator determined an abnormal result inputs a comment indicating abnormal to the label display field 950. For example, when an abnormality has actually occurred in the servo system 40 even though the determination result by the learning model is normal, the operator can input a comment indicating the fact to the label display field 550. The label display field 950 may display a normal label or an abnormal label generated based on the determination result of the abnormality degree 931 by the acquisition unit 111.

The abnormality cause display field 960 is a field for displaying the abnormality cause indicated by the abnormality cause information included in the registered operation data. In this example, since the abnormality cause is slippage of the belt connected to the servo system 40, a comment indicating that the abnormality cause is slippage is displayed. When the abnormality cause information is not associated with the search registration data, the abnormality cause display field 960 is blank. In this case, the operator may input the abnormality cause in the abnormality cause display field 960. As a result, the abnormality cause information indicated by the abnormality cause input in the abnormality cause display field 960 is stored in the operation data storage unit 151 in association with the target operation data. Accordingly, thereafter, when the target operation data is searched as the search registered operation data, the abnormality cause corresponding to the search registered operation data is displayed in the abnormality cause display field 960.

The restoration content display field 970 is a field in which the operator inputs the work content of the restoration work for the servo system 40 in which the abnormality occurs. Here, belt cleaning is input as the work content.

The acquisition unit 111 updates the target operation data by including the information input to the event summary display field 940, the label display field 950, and the restoration content display field 970 in the target operation data. The acquisition unit 111 updates the target operation data by including the abnormality cause information indicating the abnormality cause displayed in the abnormality cause display field 960 in the target operation data. Then, the acquisition unit 111 stores the updated target operation data in the operation data storage unit 151. As a result, hereinafter, the target operation data is used as the registered operation data.

As described above, according to the present embodiment, the abnormality cause indicated by the target operation data can be accurately identified, and the identified abnormality cause can be presented.

### Modification

Modifications described below can be adopted for the present disclosure.
(1) The identification device 10 may be mounted on the servo amplifier 30 or the motion controller 20, or may be mounted on a personal computer or a cloud server.
(2) The memory 15 may be mounted on the servo amplifier 30 or the motion controller 20, or may be mounted on a personal computer or a cloud server.
(3) In the first embodiment, when the acquisition unit 111 does not acquire the connection relationship information, the first identification unit 112 may identify the location of abnormality from among the plurality of servo motors M based on the abnormality degree of each of the plurality of servo motors M. The case where the connection relationship information has not been acquired corresponds to, for example, a case where graph data of the servo system 40 has not been created by an operator. In this case, the first identification unit 112 determines whether the abnormality degree of each of the plurality of servo motors M exceeds the threshold, and determines that the servo motor M in which the abnormality degree exceeds the threshold is abnormal. In this case, the display control unit 113 may emphasize the servo motor M determined to be abnormal on the display. In this case, the display control unit 113 may display a block indicating the servo motor M of which the abnormality degree is acquired in the connection relationship display field 710 of FIG. 7, and may display the mark R1 for the block indicating the servo motor M of which the abnormality degree indicates the abnormality.

The present disclosure is useful in a production facility including a servo motor.

1. An identification method for identifying a location of abnormality of a servo system including a plurality of servo motors and a connection mechanism that mechanically connects the plurality of servo motors, the identification method comprising:
a computer configured to execute:
acquiring connection relationship information indicating a mechanical connection relationship between the plurality of servo motors and the connection mechanism;
acquiring an abnormality degree of each of the plurality of servo motors;
identifying the location of abnormality from among each of the plurality of servo motors and the connection mechanism based on the abnormality degree of each of the plurality of servo motors and the connection relationship information; and
displaying the location of abnormality on a display.

2. The identification method according to claim 1, wherein
the connection relationship information includes graph data representing each of the plurality of servo motors as a plurality of blocks and representing the connection relationship by connection lines connecting the plurality of blocks, and
the graph data is generated based on an input operation by an operator.

3. The identification method according to claim 2, wherein
the computer is further configured to execute:
displaying the graph data on the display; and
displaying a mark indicating the location of abnormality in the block or the connection corresponding to the location of abnormality.

4. The identification method according to claim 1, wherein
the computer is configured to execute:
identifying the location of abnormality from among the plurality of servo motors based on the abnormality degree of each of the plurality of servo motors when the connection relationship information is not acquired; and
displaying the abnormality degree corresponding to each of the plurality of servo motors on the display, and visually highlighting the abnormality degree of the servo motor identified as the location of abnormality on the display.

5. The identification method according to claim 1, wherein
when the plurality of servo motors include a first servo motor and a second servo motor that is connected to the first servo motor via the connection mechanism and operates due to operation of the first servo motor,
the identifying of the location of abnormality includes:
determining whether the abnormality degree of each of the first servo motor and the second servo motor indicates abnormality;
identifying the connection mechanism of the first servo motor and the second servo motor as the location of abnormality when it is determined that the abnormality degrees of both the first servo motor and the second servo motor indicate abnormality; and
identifying one of the first servo motor and the second servo motor as the location of abnormality when it is determined that the abnormality degree of the one of the first servo motor and the second servo motor indicates an abnormality.

6. The identification method according to claim 1, wherein
when the servo system includes an operation unit including a plurality of cooperative servo motors that cooperatively operate among the plurality of servo motors,
the identifying of the location of abnormality includes:
determining whether the abnormality degree of each of the plurality of cooperative servo motors indicates an abnormality;
identifying the operation unit as the location of abnormality when it is determined that the abnormality degrees of all of the plurality of cooperative servo motors indicate an abnormality; and
identifying a cooperative servo motor whose abnormality degree indicates an abnormality as the location of abnormality when it is determined that all the abnormality degrees of the plurality of cooperative servo motors do not indicate an abnormality.

7. The identification method according to claim 1, wherein
the computer is further configured to execute:
acquiring target operation data from the servo system;
searching for registered operation data having a maximum similarity to the target operation data from a plurality of registered operation data preregistered in a memory and associated with abnormality cause information indicating an abnormality cause, and estimating an abnormality cause indicated by the abnormality cause information associated with the searched registered operation data as an abnormality cause of the servo system; and
displaying the estimated abnormality cause on the display.

8. The identification method according to claim 7, wherein
the target operation data and the plurality of pieces of registered operation data each include a command signal for driving the servo motor, a measurement signal of the servo motor when the servo motor operates based on the command signal, and the abnormality degree, and
the displaying on the display includes displaying the command signal, the measurement signal, and the abnormality degree included in the searched registered operation data, and the command signal, the measurement signal, and the abnormality degree included in the target operation data.

9. The identification method according to claim 8, wherein
the plurality of pieces of registered operation data further includes at least one of:
a normal or abnormal determination result by an operator;
a measurement date and time of the searched registered operation data; and
a description related to a recovery operation for returning the servo system to a normal operation, and
the displaying on the display further includes displaying at least one of the determination result, the measurement date and time, and the description related to the recovery operation that are associated with the searched registered operation data.

10. The identification method according to claim 8, wherein
the displaying on the display further includes displaying the command signal, the measurement signal, and the abnormality degree included in the searched registered operation data and the command signal, the measurement signal, and the abnormality degree included in the target operation data such that operation modes can be visually distinguishable from each other.

11. The identification method according to claim 8, wherein
the similarity is a similarity between the command signal included in the plurality of pieces of registered operation data and the command signal included in the target operation data.

12. The identification method according to claim 1, wherein
the computer is any one of a servo amplifier, a motion controller, a personal computer, and a cloud server.

13. An identification device for identifying a location of abnormality of a servo system including a plurality of servo motors and a connection mechanism that mechanically connects the plurality of servo motors, the identification device comprising a processor of the identification device configured to execute:
acquiring connection relationship information indicating a mechanical connection relationship between the plurality of servo motors and the connection mechanism;
acquiring an abnormality degree of each of the plurality of servo motors;
identifying the location of abnormality from among each of the plurality of servo motors and the connection mechanism based on the abnormality degree of each of the plurality of servo motors and the connection relationship information; and
displaying the location of abnormality on a display.

14. A non-transitory computer readable recording medium storing an identification program for causing a computer to execute an identification method for identifying a location of abnormality of a servo system including a plurality of servo motors and a connection mechanism that mechanically connects the plurality of servo motors, the identification program causing the computer to execute:
acquiring connection relationship information indicating a mechanical connection relationship between the plurality of servo motors and the connection mechanism;
acquiring an abnormality degree of each of the plurality of servo motors;
identifying the location of abnormality from among each of the plurality of servo motors and the connection mechanism based on the abnormality degree of each of the plurality of servo motors and the connection relationship information; and
displaying the location of abnormality on a display.
